(19) United States
(12) Patent Application Publication
(10) Pub. No.: US 2023/0048563 A1
(43) Pub. Date: Feb. 16, 2023

(54) COLORIMETER, INFORMATION PROCESSING APPARATUS, AND PROGRAM

(71) Applicant: Konica Minolta, Inc., Tokyo (JP)

(72) Inventors: Yoshitaka TERAOKA, Tokyo (JP); Tomomi SETOGUCHI, Tokyo (JP)

(21) Appl. No.: 17/759,074

(22) PCT Filed: Dec. 23, 2020
(86) PCT No.: PCT/JP2020/048127

§ 371 Date: Jul. 19, 2022

(30) Foreign Application Priority Data
Jan. 22, 2020 (JP) 2020-008426

(51) Int. Cl. G01J 3/46

(52) U.S. Cl. CPC G01J 3/46; G01J 2003/467

(57) ABSTRACT

A colorimeter comprises a colorimetric value obtaining means to obtain a colorimetric value by performing color measurement on a measuring sample; a reference value obtaining means to obtain a reference value; a computing means to, using a color difference formula, ΔE*₉₄, compute ΔL*₉₄, Δa*₉₄, and Δb*₉₄ with reference to the colorimetric value obtained by the colorimetric value obtaining portion and the reference value obtained by the reference value obtaining portion, the ΔL*₉₄, Δa*₉₄, and Δb*₉₄ having a relation of

ΔE*₉₄=[(ΔL*₉₄)²+(Δa*₉₄)²*(Δb*₉₄)²]^{1/2}

where the ΔL*₉₄ corresponds to a difference in lightness, the Δa*₉₄ corresponds to a difference in red and green, and the Δb*₉₄ corresponds to a difference in blue and yellow; and a display means to display computational results obtained by the computing means.

### TECHNICAL FIELD

This invention relates to: a colorimeter that is capable of computing and displaying a color difference between a reference value and a colorimetric value that is obtained by performing color measurement on a measuring sample; an information processing apparatus; and a program.

### BACKGROUND ART

There is a general color place that is referred to as the L*a*b* space: L* represents lightness, a* represents red and green, and b* represents blue and yellow.

As for a color difference, ΔL* represents a difference in lightness, Δa* represents a difference in red and green, and Δb* represents a difference in blue and yellow; and these are widely used for their intuitive feature. The sum of second powers of these is also widely used as in ΔE*_{ab}=(ΔL*² Δa*²+Δb*²)^{1/2}. There is, however, a known problem with ΔE*: a visually perceived color difference and a color difference of the colorimetric value do not match when the colors are high-chroma, for example. Meanwhile, new color difference formulas such as the ΔE*₉₄ and the CIEDE2000 are known and used for their high correlation to visual perception.

To control colors using a color difference formula that is highly consistent with visual perception, Patent Literature 1 suggests a technique of controlling colors of automotive refinishing using the color difference formula ΔE*₉₄.

### CITATION LIST

### Patent Literature

[Patent Literature 1] Japanese Unexamined Patent Application Publication No. 2001-059774

### SUMMARY OF THE INVENTION

### Technical Problem

Users, however, have difficulty in color control with the technique described in Patent Literature 1 because they cannot perceive which component is dominant, lightness, chroma, or hue according to the difference of a colorimetric value with respect to a reference value, nor the direction or quantity of the difference in the component.

The present invention, which has been made in consideration of such a technical background as described above, is aimed at providing: a colorimeter that allows users to easily perceive the quantity and direction of the difference of a colorimetric value with respect to a reference value; an information processing apparatus; and a program.

### Solution to Problem

The above-described aim can be achieved by the following means.

[1] A colorimeter comprising:
a colorimetric value obtaining means to obtain a colorimetric value by performing color measurement on a measuring sample;
a reference value obtaining means to obtain a reference value;
a computing means to compute ΔL*₉₄, Δa*₉₄, and Δb*₉₄ with reference to the colorimetric value obtained by the colorimetric value obtaining means and the reference value obtained by the reference value obtaining means, the ΔL*₉₄, Δa*₉₄, and Δb*₉₄ having a relation of a color difference formula,

ΔE*94=[(ΔL*₉₄)²+(Δa*₉₄)²+(Δb*₉₄)²]^{1/2}

where the ΔL*₉₄ corresponds to a difference in lightness, the Δa*₉₄ corresponds to a difference in red and green, and the Δb*₉₄ corresponds to a difference in blue and yellow; and
a display means to display computational results obtained by the computing means.

[2] The colorimeter as recited in the foregoing item [1], wherein the computing means calculates the ΔL*₉₄, Δa*₉₄, and Δb*₉₄ by equations presented below.

$$Δ L {*}_{94} = \frac{Δ L *}{KL \times SL} \qquad [ Equation 1 ]$$

$$Δ a {*}_{94} = \sqrt{{( \frac{Δ C *}{KC \times SC} )}^{2} + {( \frac{Δ H *}{KH \times SH} )}^{2}} cos θ$$

$$Δ b {*}_{94} = \sqrt{{( \frac{Δ C *}{KC \times SC} )}^{2} + {( \frac{Δ H *}{KH \times SH} )}^{2}} sin θ$$

[3] A colorimeter comprising:
a colorimetric value obtaining means to obtain a colorimetric value by performing color measurement on a measuring sample;
a reference value obtaining means to obtain a reference value;
a computing means to compute ΔL*_{cmc}, Δa*_{cmc}, and Δb*_{cmc} with reference to the colorimetric value obtained by the colorimetric value obtaining means and the reference value obtained by the reference value obtaining means, the ΔL*_{cmc}, Δa*_{cmc}, and Δb*_{cmc} having a relation of a color difference formula,

ΔE_{cmc}=[(ΔL*_{cmc})²+(Δa*_{cmc})²+(Δb*_{cmc})²]^{1/2}

where the ΔL*_{cmc} corresponds to a difference in lightness, the Δa*_{cmc} corresponds to a difference in red and green, and the Δb*_{cmc} corresponds to a difference in blue and yellow; and
a display means to display computational results obtained by the computing means.

[4] The colorimeter as recited in the foregoing item [3], wherein the computing means calculates the ΔL*_{cmc}, Δa*_{cmc}, and Δb*_{cmc} by equations presented below.

$$Δ {L}_{c m c}^{*} = \frac{Δ {L}^{*}}{l \times S L} Δ {a}_{cmc}^{*} = \sqrt{{( \frac{Δ {C}^{*}}{c \times S c} )}^{2} + {( \frac{Δ {H}^{*}}{S H} )}^{2}} cos θ Δ {b}_{cmc}^{*} = \sqrt{{( \frac{Δ {C}^{*}}{c \times S c} )}^{2} + {( \frac{Δ {H}^{*}}{S H} )}^{2}} sin θ \qquad [ Equation 2 ]$$

[5] A colorimeter comprising:
a colorimetric value obtaining means to obtain a colorimetric value by performing color measurement on a measuring sample;
a reference value obtaining means to obtain a reference value;
a computing means to compute ΔL*₀₀, Δa*₀₀, and Δb*₀₀ with reference to the colorimetric value obtained by the colorimetric value obtaining means and the reference value obtained by the reference value obtaining means, the ΔL*₀₀, Δa*₀₀, and Δb*₀₀ having a relation of a CIEDE2000 color difference formula,

ΔE*₀₀=[(ΔL*₀₀)²+(Δa*₀₀)²+(Δb*₀₀)²]^{1/2}

where the ΔL*₀₀ corresponds to a difference in lightness, the Δa*₀₀ corresponds to a difference in red and green, and the Δb*₀₀ corresponds to a difference in blue and yellow; and
a display means to display computational results obtained by the computing means.

[6] The colorimeter as recited in the foregoing item [5], wherein the computing means calculates the ΔL*₀₀, Δa*₀₀, and Δb*₀₀ by equations presented below.

$$Δ {L}_{00}^{*} = \frac{Δ {L}^{*}}{KL \times SL} \qquad [ Equation 3 ]$$

$$Δ {a}_{00}^{*} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} cos θ$$

$$Δ {b}_{00}^{*} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} sin θ$$

[7] A colorimeter comprising:
a colorimetric value obtaining means to obtain a colorimetric value by performing color measurement on a measuring sample;
a reference value obtaining means to obtain a reference value;
a computing means to compute ΔL*_{eff}(γ), Δa*_{eff}(γ), and Δb*_{eff}(γ) with reference to the colorimetric value obtained by the colorimetric value obtaining means and the reference value obtained by the reference value obtaining means, the ΔL*_{eff}(γ), Δa*_{eff}(γ), and Δb*_{eff}(γ) having a relation of a DIN6175-2 color difference formula,

ΔL*_{eff}(γ)=[(ΔL*_{eff}(γ))²+(Δa*_{eff}(γ))²+(Δb*_{eff}(γ))²]^{1/2}

where the ΔL*_{eff}(γ) corresponds to a difference in lightness, the Δa*_{eff}(γ) corresponds to a difference in red and green, and the Δb*_{eff}(γ) corresponds to a difference in blue and yellow; and
a display means to display computational results obtained by the computing means.

[8] The colorimeter as recited in the foregoing item [7], wherein the computing means calculates the ΔL*_{eff}(γ), Δa*_{eff}(γ), and Δb*_{eff}(γ) by equations presented below.

$$Δ {L}_{eff}^{*} ( γ ) = \frac{Δ {L}^{*} ( γ )}{gL \times SL ( γ )} \qquad [ Equation 4 ]$$

$$Δ {a}_{eff}^{*} ( γ ) = σ ( γ ) \sqrt{{( \frac{Δ {a}^{*} ( γ )}{ga \times Sa} )}^{2} + ( \frac{Δ {b}^{*} ( γ )}{gb \times Sb} )} cos θ + ( 1 - σ ( γ ) ) \sqrt{{( \frac{Δ {C}^{*} ( γ )}{gC \times S C ( γ )} )}^{2} + {( \frac{Δ {H}^{*} ( γ )}{gH \times S H ( γ )} )}^{2}} cos θ$$

$$Δ {b}_{eff}^{*} ( γ ) = σ ( γ ) \sqrt{{( \frac{Δ {a}^{*} ( γ )}{g a \times S a} )}^{2} + ( \frac{Δ {b}^{*} ( γ )}{gb \times Sb} )} sin θ + ( 1 - σ ( γ ) ) \sqrt{{( \frac{Δ {C}^{*} ( γ )}{gC \times S C ( γ )} )}^{2} + {( \frac{Δ {H}^{*} ( γ )}{gH \times S H ( γ )} )}^{2}} sin θ$$

[9] A colorimeter comprising:
a colorimetric value obtaining means to obtain a colorimetric value by performing color measurement on a measuring sample;
a reference value obtaining means to obtain a reference value;
a computing means to compute ΔL′γ, Δa′γ, and Δb′γ with reference to the colorimetric value obtained by the colorimetric value obtaining means and the reference value obtained by the reference value obtaining means, the ΔL′γ, Δa′γ, and Δb′γ having a relation of an Audi2000 color difference formula,

ΔE′γ=[(ΔL′γ)²+(Δa′γ)²+(Δb′γ)²]^{1/2}

where the ΔL*γ corresponds to a difference in lightness, the Δa*γ corresponds to a difference in red and green, and the Δb*γ corresponds to a difference in blue and yellow; and
a display means to display computational results obtained by the computing means.

The colorimeter as recited in the foregoing item [9], wherein the computing means calculates the ΔL′γ, Δa′γ, and Δb′γ by equations presented below.

$$Δ {L}_{γ}^{′} = \frac{{dL}^{*} γ}{kdL \times sdL γ} Δ {a}_{γ}^{′} = \sqrt{{( \frac{{dC}^{*} γ}{kdC \times sdC γ} )}^{2} + {( \frac{{dH}^{*} γ}{kdH \times sdH γ} )}^{2}} cos θ Δ {b}_{γ}^{′} = \sqrt{{( \frac{{dC}^{*} γ}{kdC \times sdC γ} )}^{2} + {( \frac{{dH}^{*} γ}{kdH \times sdH γ} )}^{2}} sin θ \qquad [ Equation 5 ]$$

[11] An information processing apparatus comprising:
a receiving means to receive a colorimetric value from a colorimeter, the colorimetric value being obtained by color measurement on a measuring sample;
a reference value obtaining means to obtain a reference value;
a computing means to compute ΔL*₉₄, Δa*₉₄, and Δb*₉₄ with reference to the colorimetric value received by the receiving means and the reference value obtained by the reference value obtaining means, the ΔL*₉₄, Δa*₉₄, and Δb*₉₄ having a relation of a color difference formula,

ΔE*₉₄=[(ΔL*₉₄)²+(Δa*₉₄)²+(Δb*₉₄)²]^{1/2}

where the ΔL*₉₄ corresponds to a difference in lightness, the Δa*₉₄ corresponds to a difference in red and green, and the Δb*₉₄ corresponds to a difference in blue and yellow; and
a display means to display computational results obtained by the computing means.

[12] The information processing apparatus as recited in the foregoing item [11], wherein the computing means calculates the ΔL*₉₄, Δa*₉₄, and Δb*₉₄ by equations presented below.

$$Δ {L}_{94}^{*} = \frac{Δ {L}^{*}}{KL \times SL} Δ {a}_{94}^{*} = \sqrt{{( \frac{Δ C}{KC \times SC} )}^{2} + {( \frac{∠Δ {H}^{*}}{KH \times SH} )}^{2}} cos θ Δ {b}_{94}^{*} = \sqrt{{( \frac{Δ C}{KC \times SC} )}^{2} + {( \frac{Δ {H}^{*}}{KH \times SH} )}^{2}} sin θ \qquad [ Equation 6 ]$$

[13] An information processing apparatus characterized by comprising:
a receiving means to receive a colorimetric value from a colorimeter, the colorimetric value being obtained by color measurement on a measuring sample;
a reference value obtaining means to obtain a reference value;
a computing means to compute ΔL*_{cmc}, Δa*_{cmc}, and Δb*_{cmc} with reference to the colorimetric value received by the receiving means and the reference value obtained by the reference value obtaining means, the ΔL*_{cmc}, Δa*_{cmc}, and Δb*_{cmc} having a relation of a color difference formula,

ΔE_{cmc}=[(ΔL*_{cmc})²+(Δa*_{cmc})²+(Δb*_{cmc})²]^{1/2}

where the ΔL*_{cmc} corresponds to a difference in lightness, the Δa*_{cmc} corresponds to a difference in red and green, and the Δb*_{cmc} corresponds to a difference in blue and yellow; and
a display means to display computational results obtained by the computing means.

[14] The information processing apparatus as recited in the foregoing item [13], wherein the computing means calculates the ΔL*_{cmc}, Δa*_{cmc}, and Δb*_{cmc} by equations presented below.

$$Δ {L}_{c m c}^{*} = \frac{Δ {L}^{*}}{l \times S L} Δ {a}_{cmc}^{*} = \sqrt{{( \frac{Δ {C}^{*}}{c \times S c} )}^{2} + {( \frac{Δ {H}^{*}}{S H} )}^{2}} cos θ Δ {b}_{cmc}^{*} = \sqrt{{( \frac{Δ {C}^{*}}{c \times S c} )}^{2} + {( \frac{Δ {H}^{*}}{S H} )}^{2}} sin θ \qquad [ Equation 7 ]$$

[15] An information processing apparatus characterized by comprising:
a receiving means to receive a colorimetric value from a colorimeter, the colorimetric value being obtained by color measurement on a measuring sample;
a reference value obtaining means to obtain a reference value;
a computing means to compute ΔL*₀₀, Δa*₀₀, and Δb*₀₀ with reference to the colorimetric value received by the receiving means and the reference value obtained by the reference value obtaining means, the ΔL*₀₀, Δa*₀₀, and Δb*₀₀ having a relation of a CIEDE2000 color difference formula,

ΔE*₀₀=[(ΔL*₀₀)²+(Δa*₀₀)²+(Δb*₀₀)²]^{1/2}

where the ΔL*₀₀ corresponds to a difference in lightness, the Δa*₀₀ corresponds to a difference in red and green, and the Δb*₀₀ corresponds to a difference in blue and yellow; and
a display means to display computational results obtained by the computing means.

[16] The information processing apparatus as recited in the foregoing item [15], wherein the computing means calculates the ΔL*₀₀, Δa*₀₀, and Δb*₀₀ by equations presented below.

$$Δ {L}_{00}^{*} = \frac{Δ {L}^{*}}{KL \times SL} \qquad [ Equation 8 ]$$

$$Δ {a}_{00}^{*} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} cos θ$$

$$Δ {b}_{00}^{*} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} sin θ$$

[17] An information processing apparatus characterized by comprising:
a receiving means to receive a colorimetric value from a colorimeter, the colorimetric value being obtained by color measurement on a measuring sample;
a reference value obtaining means to obtain a reference value;
a computing means to compute ΔL*_{eff}(γ), Δa*_{eff}(γ), and Δb*_{eff}(γ) with reference to the colorimetric value received by the receiving means and the reference value obtained by the reference value obtaining means, the ΔL*_{eff}(γ), Δa*_{eff}(γ), and Δb*_{eff}(γ) having a relation of a DIN6175-2 color difference formula,

ΔL*_{eff}(γ)=[(ΔL*_{eff}(γ))²+(Δa*_{eff}(γ))²+(Δb*_{eff}(γ))²]^{1/2}

where the ΔL*_{eff}(γ) corresponds to a difference in lightness, the Δa*_{eff}(γ) corresponds to a difference in red and green, and the Δb*_{eff}(γ) corresponds to a difference in blue and yellow; and
a display means to display computational results obtained by the computing means.

The information processing apparatus as recited in the foregoing item [17], wherein the computing means calculates the ΔL*_{eff}(γ), Δa*_{eff}(γ), and Δb*_{eff}(γ) by equations presented below.

$$Δ {L}_{eff}^{*} ( γ ) = \frac{Δ {L}^{*} ( γ )}{gL \times SL ( γ )} \qquad [ Equation 9 ]$$

$$Δ {a}_{eff}^{*} ( γ ) = σ ( γ ) \sqrt{{( \frac{Δ {a}^{*} ( γ )}{ga \times Sa} )}^{2} + ( \frac{Δ {b}^{*} ( γ )}{gb \times Sb} )} cos θ + ( 1 - σ ( γ ) ) \sqrt{{( \frac{Δ {C}^{*} ( γ )}{gC \times S C ( γ )} )}^{2} + {( \frac{Δ {H}^{*} ( γ )}{gH \times S H ( γ )} )}^{2}} cos θ$$

$$Δ {b}_{eff}^{*} ( γ ) = σ ( γ ) \sqrt{{( \frac{Δ {a}^{*} ( γ )}{g a \times S a} )}^{2} + ( \frac{Δ {b}^{*} ( γ )}{gb \times Sb} )} sin θ + ( 1 - σ ( γ ) ) \sqrt{{( \frac{Δ {C}^{*} ( γ )}{gC \times S C ( γ )} )}^{2} + {( \frac{Δ {H}^{*} ( γ )}{gH \times S H ( γ )} )}^{2}} sin θ$$

[19] An information processing apparatus comprising:
a receiving means to receive a colorimetric value from a colorimeter, the colorimetric value being obtained by color measurement on a measuring sample;
a reference value obtaining means to obtain a reference value;
a computing means to compute ΔL′γ, Δa′γ, and Δb′γ with reference to the colorimetric value received by the receiving means and the reference value obtained by to the reference value obtaining means, the ΔL′γ, Δa′γ, and Δb′γ having a relation of an Audi2000 color difference formula,

ΔE′γ=[(ΔL′γ)²+(Δa′γ)²+(Δb′γ)²]^{1/2}

where the ΔL*γ corresponds to a difference in lightness, the Δa*γ corresponds to a difference in red and green, and the Δb*γ corresponds to a difference in blue and yellow; and
a display means to display computational results obtained by the computing means.

The information processing apparatus as recited in the foregoing item [19], wherein the computing means calculates the ΔL′γ, Δa′γ, and Δb′γ by equations presented below.

$$Δ {L}_{γ}^{′} = \frac{{dL}^{*} γ}{kdL \times sdL γ} Δ {a}_{γ}^{′} = \sqrt{{( \frac{{dC}^{*} γ}{kdC \times sdC γ} )}^{2} + {( \frac{{dH}^{*} γ}{kdH \times sdH γ} )}^{2}} cos θ Δ {b}_{γ}^{′} = \sqrt{{( \frac{{dC}^{*} γ}{kdC \times sdC γ} )}^{2} + {( \frac{{dH}^{*} γ}{kdH \times sdH γ} )}^{2}} sin θ \qquad [ Equation 10 ]$$

[21] A program to make a computer execute:
a receiving step of receiving a colorimetric value from a colorimeter, the colorimetric value being obtained by color measurement on a measuring sample;
a reference value obtaining step of obtaining a reference value;
a computing step of computing ΔL*₉₄, Δa*₉₄, and Δb*₉₄ with reference to the colorimetric value received by the receiving step and the reference value obtained by a reference value obtaining means, the ΔL*₉₄, Δa*₉₄, and Δb*₉₄ having a relation of a color difference formula,

ΔE*₉₄=[(ΔL*₉₄)²+(Δa*₉₄)²+(Δb*₉₄)²]^{1/2}

where the ΔL*₉₄ corresponds to a difference in lightness, the Δa*₉₄ corresponds to a difference in red and green, and the Δb*₉₄ corresponds to a difference in blue and yellow; and
a displaying step of displaying computational results on a display means, the computational results being obtained by the computing step.

The program as recited in the foregoing item [21], to make the computer execute, in the computing step, a process of calculating the ΔL*₉₄, Δa*₉₄, and Δb*₉₄ by equations presented below.

$$Δ {L}_{94}^{*} = \frac{Δ {L}^{*}}{KL \times SL} Δ {a}_{94}^{*} = \sqrt{{( \frac{Δ C}{KC \times SC} )}^{2} + {( \frac{∠Δ {H}^{*}}{KH \times SH} )}^{2}} cos θ Δ {b}_{94}^{*} = \sqrt{{( \frac{Δ C}{KC \times SC} )}^{2} + {( \frac{Δ {H}^{*}}{KH \times SH} )}^{2}} sin θ \qquad [ Equation 11 ]$$

[23] A program to make a computer execute:
a receiving step of receiving a colorimetric value from a colorimeter, the colorimetric value being obtained by color measurement on a measuring sample;
a reference value obtaining step of obtaining a reference value;
a computing step of computing ΔL*_{cmc}, Δa*_{cmc}, and Δb*_{cmc} with reference to the colorimetric value received by the receiving step and the reference value obtained by the reference value obtaining step, the ΔL*_{cmc}, Δa*_{cmc}, and Δb*_{cmc} having a relation of a color difference formula,

ΔE_{cmc}=[(ΔL*_{cmc})²+(Δa*_{cmc})²+(Δb*_{cmc})²]^{1/2}

where the ΔL*_{cmc} corresponds to a difference in lightness, the Δa*_{cmc} corresponds to a difference in red and green, and the Δb*_{cmc} corresponds to a difference in blue and yellow; and
a displaying step of displaying computational results on a display means, the computational results being obtained by the computing step.

The program as recited in the foregoing item [23], to make the computer execute, in the computing step, a process of calculating the ΔL*_{cmc}, Δa*_{cmc}, and Δb*_{cmc} by equations presented below.

$$Δ {L}_{c m c}^{*} = \frac{Δ {L}^{*}}{l \times S L} Δ {a}_{cmc}^{*} = \sqrt{{( \frac{Δ {C}^{*}}{c \times S c} )}^{2} + {( \frac{Δ {H}^{*}}{S H} )}^{2}} cos θ Δ {b}_{cmc}^{*} = \sqrt{{( \frac{Δ {C}^{*}}{c \times S c} )}^{2} + {( \frac{Δ {H}^{*}}{S H} )}^{2}} sin θ \qquad [ Equation 12 ]$$

[25] A program to make a computer execute:
a receiving step of receiving a colorimetric value from a colorimeter, the colorimetric value being obtained by color measurement on a measuring sample;
a reference value obtaining step of obtaining a reference value;
a computing step of computing ΔL*₀₀, Δa*₀₀, and Δb*₀₀ with reference to the colorimetric value received by the receiving step and the reference value obtained by the reference value obtaining step, the ΔL*₀₀, Δa*₀₀, and Δb*₀₀ having a relation of a CIEDE2000 color difference formula,

ΔE*₀₀=[(ΔL*₀₀)²+(Δa*₀₀)²+(Δb*₀₀)²]^{1/2}

where the ΔL*₀₀ corresponds to a difference in lightness, the Δa*₀₀ corresponds to a difference in red and green, and the Δb*₀₀ corresponds to a difference in blue and yellow; and
a displaying step of displaying computational results on a display means, the computational results being obtained by the computing step.

The program as recited in the foregoing item [25], to make the computer execute, in the computing step, a process of calculating the ΔL*₀₀, Δa*₀₀, and Δb*₀₀ by equations presented below.

$$Δ {L}_{00}^{*} = \frac{Δ {L}^{*}}{KL \times SL} \qquad [ Equation 13 ]$$

$$Δ {a}_{00}^{*} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} cos θ$$

$$Δ {b}_{00}^{*} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} sin θ$$

[27] A program to make a computer execute:
a receiving step of receiving a colorimetric value from a colorimeter, the colorimetric value being obtained by color measurement on a measuring sample;
a reference value obtaining step of obtaining a reference value;
a computing step of computing ΔL*_{eff}(γ), Δa*_{eff}(γ), and Δb*_{eff}(γ) with reference to the colorimetric value received by the receiving step and the reference value obtained by the reference value obtaining step, the ΔL*_{eff}(γ), Δa*_{eff}(γ), and Δb*_{eff}(γ) having a relation of a DIN6175-2 color difference formula,

ΔL*_{eff}(γ)=[(ΔL*_{eff}(γ))²+(Δa*_{eff}(γ))²+(Δb*_{eff}(γ))²]^{1/2}

where the ΔL*_{eff}(γ) corresponds to a difference in lightness, the Δa*_{eff}(γ) corresponds to a difference in red and green, and the Δb*_{eff}(γ) corresponds to a difference in blue and yellow; and
a displaying step of displaying computational results on a display means, the computational results being obtained by the computing step.

The program as recited in the foregoing item [27], to make the computer execute, in the computing step, a process of calculating the ΔL*_{eff}(γ), Δa*_{eff}(γ), and Δb*_{eff}(γ) by equations presented below.

$$Δ {L}_{eff}^{*} ( γ ) = \frac{Δ {L}^{*} ( γ )}{gL \times SL ( γ )} \qquad [ Equation 14 ]$$

$$Δ {a}_{eff}^{*} ( γ ) = σ ( γ ) \sqrt{{( \frac{Δ {a}^{*} ( γ )}{ga \times Sa} )}^{2} + ( \frac{Δ {b}^{*} ( γ )}{gb \times Sb} )} cos θ + ( 1 - σ ( γ ) ) \sqrt{{( \frac{Δ {C}^{*} ( γ )}{gC \times S C ( γ )} )}^{2} + {( \frac{Δ {H}^{*} ( γ )}{gH \times S H ( γ )} )}^{2}} cos θ$$

$$Δ {b}_{eff}^{*} ( γ ) = σ ( γ ) \sqrt{{( \frac{Δ {a}^{*} ( γ )}{g a \times S a} )}^{2} + ( \frac{Δ {b}^{*} ( γ )}{gb \times Sb} )} sin θ + ( 1 - σ ( γ ) ) \sqrt{{( \frac{Δ {C}^{*} ( γ )}{gC \times S C ( γ )} )}^{2} + {( \frac{Δ {H}^{*} ( γ )}{gH \times S H ( γ )} )}^{2}} sin θ$$

[29] A program to make a computer execute:
a receiving step of receiving a colorimetric value from a colorimeter, the colorimetric value being obtained by color measurement on a measuring sample;
a reference value obtaining step of obtaining a reference value;
a computing step of computing ΔL′γ, Δa′γ, and Δb′γ with reference to the colorimetric value received by the receiving step and the reference value obtained by the reference value obtaining step, the ΔL′γ, Δa′γ, and Δb′γ having a relation of an Audi2000 color difference formula,

ΔE′γ=[(ΔL′γ)²+(Δa′γ)²+(Δb′γ)²]^{1/2}

where the ΔL*γ corresponds to a difference in lightness, the Δa*γ corresponds to a difference in red and green, and the Δb*γ corresponds to a difference in blue and yellow; and
a displaying step of displaying computational results on a display means, the computational results being obtained by the computing step.

The program as recited in the foregoing item [29], to make the computer execute, in the computing step, a process of calculating the ΔL′γ, Δa′γ, and Δb′γ by equations presented below.

$$Δ {L}_{γ}^{′} = \frac{{dL}^{*} γ}{kdL \times sdL γ} Δ {a}_{γ}^{′} = \sqrt{{( \frac{{dC}^{*} γ}{kdC \times sdC γ} )}^{2} + {( \frac{{dH}^{*} γ}{kdH \times sdH γ} )}^{2}} cos θ Δ {b}_{γ}^{′} = \sqrt{{( \frac{{dC}^{*} γ}{kdC \times sdC γ} )}^{2} + {( \frac{{dH}^{*} γ}{kdH \times sdH γ} )}^{2}} sin θ \qquad [ Equation 15 ]$$

### Advantageous Effects of the Invention

According to the inventions described in the foregoing items [1], [11], and [21], the ΔL*₉₄, Δa*₉₄, and Δb*₉₄, respectively, corresponding to a difference in lightness, a difference in red and green, and a difference in blue and yellow, are computed with reference to the colorimetric value obtained by color measurement on the measuring sample and the reference value, using the color difference formula ΔE*₉₄, and displayed. So, users can easily perceive the quantity and direction of a color difference of the colorimetric value with respect to the reference value.

According to the inventions described in the foregoing items [2], [12], and [22], the ΔL*₉₄, Δa*₉₄, and Δb*₉₄, respectively, corresponding to a difference in lightness, a difference in red and green, and a difference in blue and yellow will be successfully computed.

According to the inventions described in the foregoing items [3], [13], and [23], the ΔL*_{cmc}, Δa*_{cmc}, and Δb*_{cmc}, respectively, corresponding to a difference in lightness, a difference in red and green, and a difference in blue and yellow, are computed with reference to the colorimetric value obtained by color measurement on the measuring sample and the reference value, using the color difference formula ΔE_{cmc}, and displayed. So, users can easily perceive the quantity and direction of a color difference of the colorimetric value with respect to the reference value.

According to the inventions described in the foregoing items [4], [14], and [24], the ΔL*_{cmc}, Δa*_{cmc}, and Δb*_{cmc}, respectively, corresponding to a difference in lightness, a difference in red and green, and a difference in blue and yellow will be successfully computed.

According to the inventions described in the foregoing items [5], [15], and [25], the ΔL*₀₀, Δa*₀₀, and Δb*₀₀, respectively, corresponding to a difference in lightness, a difference in red and green, and a difference in blue and yellow, are computed with reference to the colorimetric value obtained by color measurement on the measuring sample and the reference value, using the CIEDE2000 color difference formula ΔE₀₀, and displayed. So, users can easily perceive the quantity and direction of a color difference of the colorimetric value with respect to the reference value.

According to the inventions described in the foregoing items [6], [16], and [26], the ΔL*₀₀, Δa*₀₀, and Δb*₀₀, respectively, corresponding to a difference in lightness, a difference in red and green, and a difference in blue and yellow will be successfully computed.

According to the inventions described in the foregoing items [7], [17], and [27], the ΔL*_{eff}(γ), Δa*_{eff}(γ), and Δb*_{eff}(γ), respectively, corresponding to a difference in lightness, a difference in red and green, and a difference in blue and yellow, are computed with reference to the colorimetric value obtained by color measurement on the measuring sample and the reference value, using the DIN6175-2 color difference formula ΔE_{eff}(γ), and displayed. So, users can easily perceive the quantity and direction of a color difference of the colorimetric value with respect to the reference value.

According to the inventions described in the foregoing items [8], [18], and [28], the ΔL*_{eff}(γ), Δa*_{eff}(γ), and Δb*_{eff}(γ), respectively, corresponding to a difference in lightness, a difference in red and green, and a difference in blue and yellow will be successfully computed.

According to the inventions described in the foregoing items [9], [19], and [29], the ΔL′γ, Δa′γ, and Δb′γ, respectively, corresponding to a difference in lightness, a difference in red and green, and a difference in blue and yellow, are computed with reference to the colorimetric value obtained by color measurement on the measuring sample and the reference value, using the Audi2000 color difference formula ΔE′γ, and displayed. So, users can easily perceive the quantity and direction of a color difference of the colorimetric value with respect to the reference value.

According to the inventions described in the foregoing items [10], [20], and [30], the ΔL′γ, Δa′γ, and Δb′γ, respectively, corresponding to a difference in lightness, a difference in red and green, and a difference in blue and yellow will be successfully computed.

### BRIEF DESCRIPTION OF THE DRAWINGS

FIG. 1 is a block diagram illustrating a configuration of a colorimeter according to one embodiment of the present invention.

FIG. 2 is a perspective view illustrating an exterior of the colorimeter according to this embodiment.

FIG. 3 is a flowchart representing operations of the colorimeter of FIG. 1.

FIG. 4(a) is an enlarged view of a color discrimination eclipse (a range in which the human eye cannot differentiate the colors) in the L*a*b* space that is a general color space; FIG. 4(b) is an enlarged view of the color discrimination eclipse in a case of the color difference formula ΔE*₉₄.

FIGS. 5(a), 5(b), and 5(c) are diagrams for reference in describing that ΔE*₉₄ can be split into a direction of A*a and a direction of A*b.

FIG. 6 illustrates the relations between ΔE*₉₄, ΔC*₉₄, and ΔH*₉₄ in a case in which ΔE*₉₄ is plotted with transformed coordinate axes of the L*a*b* space.

FIG. 7(a) is a graph in which a*, b* are plotted as examples of a reference value and colorimetric values; FIG. 7(b) is an enlarged graph of the FIG. 7(a).

FIG. 8 illustrates the relations between ΔE_{cmc}, ΔC*_{cmc}, and ΔH*_{cmc} in a case in which ΔE_{cmc} is plotted with transformed coordinate axes of the L*a*b* space.

FIG. 9 relates to another embodiment of the present invention and is a block diagram illustrating a configuration when an information processing apparatus performs computing.

### DESCRIPTION OF THE EMBODIMENTS

Hereinafter, some embodiments of the present invention will be described with reference to the drawings.

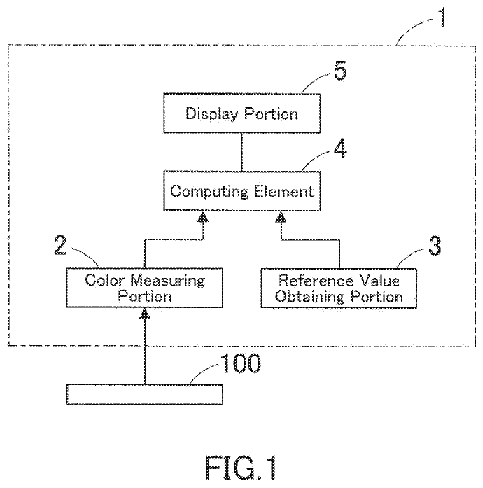

FIG. 1 is a block diagram illustrating a configuration of a colorimeter according to one embodiment of the present invention. This colorimeter 1 is provided with a color measuring portion 2, a reference value obtaining portion 3, a computing element 4, and a display portion 5.

The color measuring portion (corresponding to a colorimetric value obtaining means) 2 has a publicly-known configuration that obtains a colorimetric value by performing color measurement on a measuring sample 100.

The reference value obtaining portion 3 obtains a reference value of a reference color, which is to be compared to the colorimetric value obtained by the color measuring portion 2. The reference value obtaining portion 3 may obtain a reference value by actually measuring a reference color (reference color measurement); the reference value obtaining portion 3 may obtain a value that is retained as a reference value or a theoretical value on a storage means embedded in the colorimeter or an external storage means (neither of them shown in the figure). In a case in which the reference value obtaining portion 3 obtains a reference value by actually measuring a reference color, the color measuring portion 2 can concurrently serve as the reference value obtaining portion 3.

The computing element 4 consists of a computer that is provided with a CPU, a RAM, and the like and performs computing by applying a predetermined color difference formula with reference to the colorimetric value obtained by the color measuring portion 2 and the reference value obtained by the reference value obtaining portion 3. This will be later described in details.

The display portion 5 consists of a liquid-crystal display device, for example, and displays computational results obtained by the computing element 4, and the like. These may be displayed on the display portion 5 in a numerical form, a graphical form, or another pictorial form.

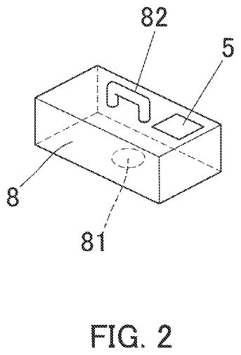

FIG. 2 is a perspective view illustrating an exterior of the colorimeter 1 according to this embodiment. In this embodiment, the colorimeter 1 is configured to be of a hand-held and portable type.

Specifically, the color measuring portion 2, the reference value obtaining portion 3, and the computing element 4 are housed in a case 8. More specifically, a handle portion 82 for carry and the display portion 5 are mounted on a top face of the case 8, and an opening 81 for measuring the color of a measuring target part of the measuring sample 100 is formed in an underface of the case 8.

To use the colorimeter 1 shown in FIG. 2, a user should position the opening 81 in the underface of the case 8 at the measuring target part of the measuring sample 100 by handling the handle portion 82. In this state of things, the color measuring portion 2, which is housed in the case 8, performs color measurement, and the computing element 4 performs computing using a color difference formula with reference to the colorimetric value obtained by the color measuring portion 2 and the reference value obtained by the reference value obtaining portion 3, and then the display portion 5 displays the computational results.

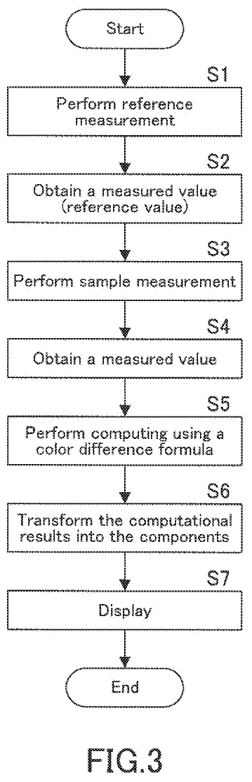

FIG. 3 is a flowchart representing operations of the colorimeter 1.

In Step S1, reference measurement is performed by the color measuring portion 2, which concurrently serves as the reference value measuring portion 3. In Step S2, measured values (reference values), (L*t, a*t, b*t) are obtained. As described earlier, the reference values may be predetermined values.

Subsequently, measurement on the measuring sample 100 (color difference measurement) is performed in Step S3. In Step S4, colorimetric values, (L*s, a*s, b*s) are obtained.

Then, in Step S5, a color difference (for example, ΔE*₉₄) is computed by the computing element 4 with reference to the reference values obtained in Step S2 and the colorimetric values obtained in Step S4. In Step S6, the computational results are converted into ΔL*₉₄, Δa*₉₄, and Δb*₉₄ components. In Step S7, the obtained results are displayed on the display portion 5 in a split form.

The user thus can find a direction (±) of the difference in each component according to the measured results displayed on the display portion 5 and perform color adjustment with reference to the results.

Hereinafter, computational processes using practical color difference formulas will be to described.

### Embodiment 1

This embodiment is an embodiment using a color difference formula, ΔE*₉₄ which is

ΔE*94=[(ΔL*₉₄)²+(ΔC^{*}₉₄)²⁺(ΔH*₉₄)²]^{1/2}

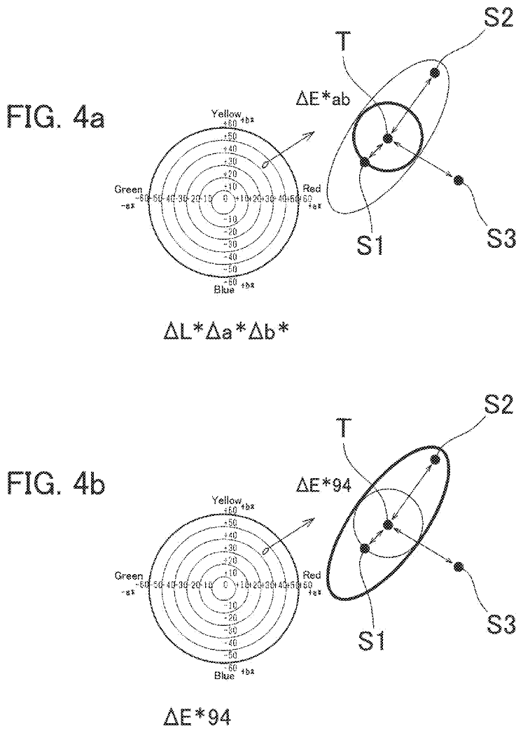

FIG. 4(a) is an enlarged view of a color discrimination eclipse (a range in which the human eye cannot differentiate the colors) in the L*a*b* space that is a general color space; FIG. 4(b) is an enlarged view of the color discrimination eclipse in a case of the color difference formula ΔE*₉₄.

In the L*a*b* space that is a general color space, ΔL* represents a difference in lightness, Δa* represents a difference in red and green, and Δb* represents a difference in blue and yellow. Therefore, an evaluation of the three values will be able to bring the directions of the differences (in lightness, red, and yellow components) of the colorimetric values of the sample 100 (hereinafter referred to as “samples”) with respect to the references. In a color gamut with a differently-shaped color discrimination eclipse, for example, in a high-chroma color gamut, however, the measured value is slightly correlated to the quantity of a visually perceived color difference. That is, a color difference perceived by the human eye depends on the directions of chroma and hue the color difference indicates. So, colors can be perceived as the same or different even when the color differences are the same value (an equal distance). This effect is not taken into account. For example, as referred to FIG. 4(a), samples S1 and S2, which are in the same color discrimination eclipse as a reference value (hereinafter also referred to as “target”) T, are perceived as the same color as the target T. The sample S2 is at the same distance from the target T as a sample S3 which is outside the color discrimination eclipse, but the sample S3 is perceived as a color different from the target T and the sample 2.

The color difference formula ΔE*₉₄ indicated in FIG. 4(b) takes into account color discrimination eclipses that change in high-chroma regions. The use of the present color difference formula will be able to bring color difference values that are highly consistent with visually perceived differences. There is, however, a problem with it. Since it outputs only one single index “ΔE*₉₄”, the directions of the differences in the three components, lightness, red, and yellow, which are often used in the field of color control, cannot be perceived, and this makes adjustment difficult. That is, as referred to FIG. 4(b), the sample S2 is at the same distance from the target T as the sample S3 which is outside the color discrimination eclipse, but the sample S3 is perceived as a color different from the target T and the sample 2, as in the previous case.

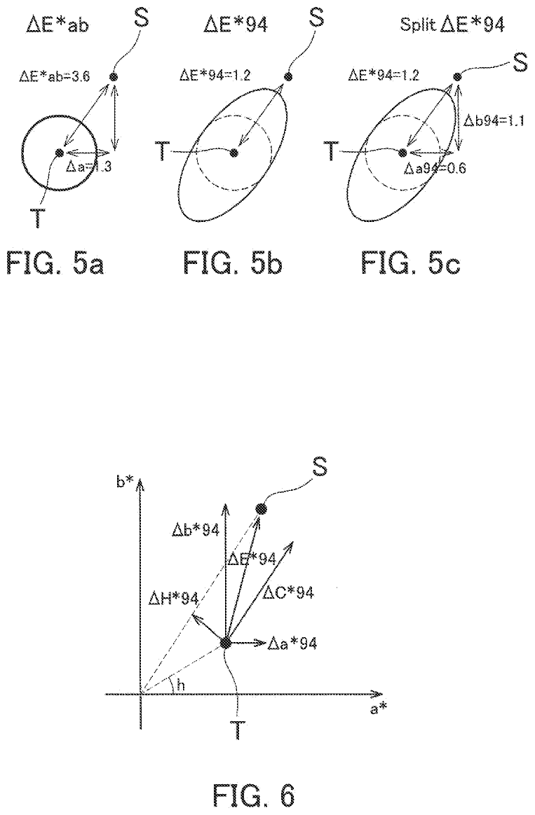

FIG. 5(a) indicates ΔE*_{ab}; FIG. 5(b) indicates ΔE*₉₄, which is highly consistent with visual perception but hardly can be applied to color control because one single index does not bring the directions of differences. In this embodiment, an orthogonal projection of every component in the L*C*h space or the L*a*b* space is calculated as referred to FIG. 5(c), and a color difference formula that is highly correlated to visual perception is suggested. This enables perception of the directions of color differences and makes color control at workplaces easy. In the example of FIG. 5(c), ΔE*₉₄ is split into 0.6 in a direction of A*a and 1.1 in a direction of A*b when ΔE*₉₄ is 1.2.

A formula to calculate an orthogonal projection in the L*a*b* space can be derived as described below, for example.

In a case in which the coordinate axes of the L*a*b* space are transformed such that a difference between two points in the space is split into a direction of the vertical axis and a direction of the horizontal axis, by a parametric factor, a weighting factor, the relations between ΔE*₉₄, ΔC*₉₄, and ΔH*₉₄ will be as shown in FIG. 6. Here, ΔL* is 0 for the sake of convenience. In FIG. 6, T is short for target, and S is short for sample.

When the target T is defined by (a*, b*)=(a0, b0) and the sample S is defined by (a*, b*)=(a1, b1), an angle θ formed by the vector ΔE*₉₄ with respect to an axis a* is expressed by

θ=tan⁻¹(Δb*/Δa*), where Δa* is a1 minus a0, and Δb* is b1 minus b0

When, in the color difference formula ΔE*₉₄, a change in lightness represents ΔL*₉₄, a change in red and green represents Δa*₉₄, and a change in blue and yellow represents Δb*₉₄, these are expressed by the following equations.

$$Δ {L}_{94}^{*} = \frac{Δ {L}^{*}}{KL \times SL} Δ {a}_{94}^{*} = \sqrt{{( \frac{Δ C}{KC \times SC} )}^{2} + {( \frac{∠Δ {H}^{*}}{KH \times SH} )}^{2}} cos θ Δ {b}_{94}^{*} = \sqrt{{( \frac{Δ C}{KC \times SC} )}^{2} + {( \frac{Δ {H}^{*}}{KH \times SH} )}^{2}} sin θ \qquad [ Equation 16 ]$$

Furthermore, the sum of these components has a relation of

ΔE*94=[(ΔL*₉₄)²+(Δa*₉₄)²+(Δb*₉₄)²]^{1/2}

This means, these correspond to the values of the components when ΔE*₉₄ is split into a direction of ΔL*, a direction of Δa*, and a direction of Δb*.

Hereinafter, a specific example will be described. For example, this is a case in which:

Target (L*, a*, b*)=(50, 80, 0)

Sample A (L*, a*, b*)=(50, 82, 0)

Sample B (L*, a*, b*)=(50, 80, 2)

Sample C (L*, a*, b*)=(50, 84.2, 2)

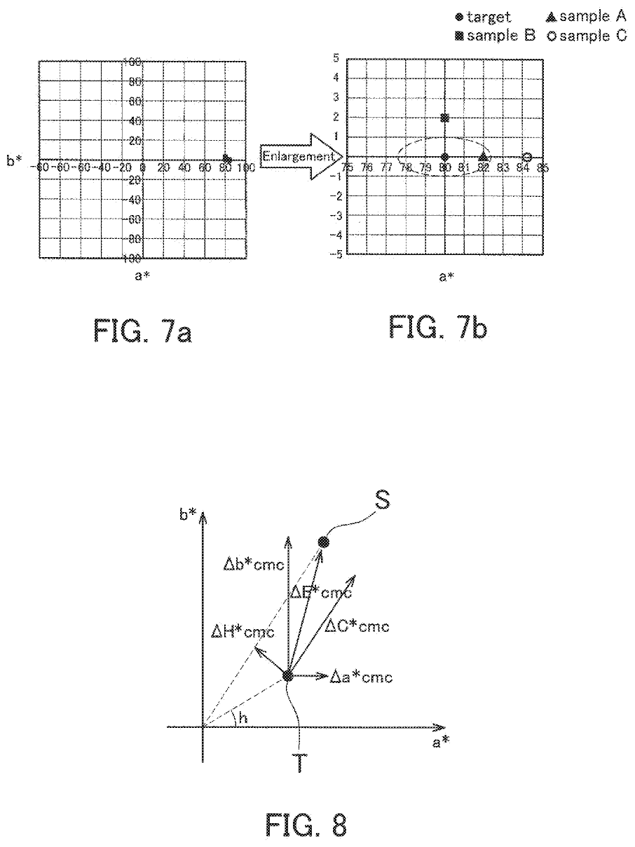

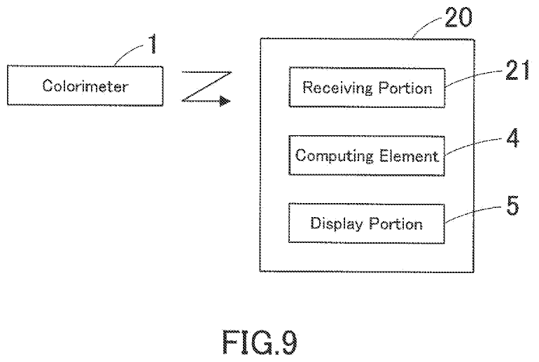

FIGS. 7(a) and 7(b) are graphs in which a* and b* of the target T and the samples A to C are plotted. FIG. 7(b) is an enlarged view of FIG. 7(a). In FIG. 7(b), a part enclosed by a dashed line is a visually identical color range i.e., a range in which the human eye cannot differentiate the colors.

In high-chroma regions, the human eye is more sensitive to a difference in hue than to a difference in chroma. According to this visual property, a visually perceived difference with respect to the target will be as follows, for example:

Sample A: OK (existence of the difference)

Sample B: NG (nonexistence of the difference)

Sample C: NG (nonexistence of the difference)

Meanwhile, a calculation of the color difference formula ΔE* will bring the following results:

Sample A: ΔE*=2.0

Sample B: ΔE*=2.0

Sample C: ΔE*=4.2

There is a visually perceived difference between the samples A and B but no difference in their ΔE*, which means the formula is inconsistent with visual perception.

When (kL, kC, kH) is (1, 1, 1), a calculation of the color difference formula ΔE*₉₄ will bring the following results:

Sample A: ΔE*94=0.43

Sample B: ΔE*94=0.91

Sample C: ΔE*94=0.91

This means the formula is consistent with visual perception, according to which there is a difference between the samples A and B.

The samples B and C have the same value of ΔE*₉₄ although they are in different directions in the color space. This does not help to adjust colors when the colorimetric values are different.

To solve this, a calculation of the split formula of ΔE*₉₄ will bring the following results:

Sample A: (ΔL*₉₄, Δa*₉₄, Δb*₉₄, ΔE*₉₄)=(0, 0.43, 0, 0.43)

Sample B: (ΔL*₉₄, Δa*₉₄, Δb*₉₄, ΔE*₉₄)=(0, 0, 0.91, 0.91)

Sample C: (ΔL*₉₄, Δa*₉₄, Δb*₉₄, ΔE*₉₄)=(0, 0.91, 0, 0.91)

These confirm that the values of ΔE*₉₄ are consistent with the visually perceived quantities of the differences, and the values of ΔL*₉₄, Δa*₉₄, and Δb*₉₄ indicate directions of the differences. So, this will help to adjust colors when the colorimetric values are different.

### Embodiment 2

This embodiment is an embodiment using a color difference formula, ΔE_{cmc} presented below.

$$Δ E = {[ {( \frac{Δ {L}^{⋆}}{l \cdot {S}_{L}} )}^{2} + {( \frac{Δ {C}^{⋆}}{c \cdot {S}_{C}} )}^{2} + {( \frac{Δ {H}^{⋆}}{{S}_{H}} )}^{2} ]}^{1 / 2} \qquad [ Equation 17 ]$$

Similarly, ΔE_{cmc} is also split into vectors in the a*-b* space, so the relations between ΔE_{cmc}, ΔC*_{cmc}, and ΔH*_{cmc} will be as shown in FIG. 8.

When the target T is defined by (a*, b*)=(a0, b0) and the sample S is defined by (a*, b*)=(a1, b1), an angle θ formed by the vector ΔE_{cmc} with respect to an axis a* is expressed by

θ=tan⁻¹(Δb*/Δa*), where Δa* is a1 minus a0, and Δb* is b1 minus b0

When, in the color difference formula ΔE_{cmc}, a change in lightness represents ΔL*_{cmc}, a change in red and green represents Δa*_{cmc}, and a change in blue and yellow represents Δb*_{cmc}, these are expressed by the following equations.

$$Δ {L}_{cmc}^{*} = \frac{Δ {L}^{*}}{l \times S L} \qquad [ Equation 18 ]$$

$$Δ {a}_{cmc}^{⋆} = \sqrt{{( \frac{Δ {C}^{⋆}}{c \times Sc} )}^{2} + {( \frac{Δ {H}^{⋆}}{SH} )}^{2}} cos θ$$

$$Δ {b}_{cmc}^{*} = \sqrt{{( \frac{Δ {C}^{⋆}}{c \times Sc} )}^{2} + {( \frac{Δ {H}^{⋆}}{SH} )}^{2}} sin θ$$

Furthermore, the sum of these components has a relation of

ΔE_{cmc}=[(ΔL*_{cmc})²+(Δa*_{cmc})²+(Δb*_{cmc})²]^{1/2}

This means, these correspond to the values of the components when ΔE_{cmc} is split into a direction of ΔL*, a direction of Δa*, and a direction of Δb*. The computational results will be displayed on the display portion 5.

### Embodiment 3

This embodiment is an embodiment using the CIEDE2000 color difference formula presented below.

$$Δ {E}_{00} = {\{ {( \frac{Δ {L}^{′}}{{k}_{L} \cdot {S}_{L}} )}^{2} + {( \frac{Δ {C}^{′}}{{k}_{C} \cdot {S}_{C}} )}^{2} + {( \frac{Δ {H}^{′}}{{k}_{H} \cdot {S}_{H}} )}^{2} + {R}_{t} \cdot \frac{Δ {C}^{′}}{{k}_{C} \cdot {S}_{C}} \cdot \frac{Δ {H}^{′}}{{k}_{H} \cdot {S}_{H}} \}}^{1 / 2} \qquad [ Equation 19 ]$$

Similarly, ΔE₀₀ is also split into vectors in the a*-b* space. When the target T is defined by (a*, b*)=(a0, b0) and the sample S is defined by (a*, b*)=(a1, b1), an angle θ formed by the vector ΔE₀₀ with respect to an axis a* is expressed by

θ=tan⁻¹(Δb*/Δa*), where Δa* is a1 minus a0, and Δb* is b1 minus b0

When, in the color difference formula ΔE₀₀, a change in lightness represents ΔL*₀₀, a change in red and green represents Δa*₀₀, and a change in blue and yellow represents Δb*₀₀, these are expressed by the following equations.

$$Δ {L}_{00}^{*} = \frac{Δ {L}^{*}}{KL \times SL} \qquad [ Equation 20 ]$$

$$Δ {a}_{00}^{⋆} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} cos θ$$

$$Δ {b}_{00}^{⋆} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} sin θ$$

Furthermore, the sum of these components has a relation of

ΔE*₀₀=[(ΔL*₀₀)²+(Δa*₀₀)²+(Δb*₀₀)²]^{1/2}

This means, these correspond to the values of the components when ΔE₀₀ is split into a direction of ΔL*, a direction of Δa*, and a direction of Δb*. The computational results will be displayed on the display portion 5.

### Embodiment 4

This embodiment is an embodiment using the DIN6175-2 color difference formula.

The DIN6175-2 color difference formula presented below is often used as an index for evaluating a color difference of a metallic or pearlescent coating which affects the perceived lightness and color of an object depending on the observation angle.

When achromatic colors are defined by C*_{ab}<10 or when pastel colors are defined by C*_{ab}<18 and L*_{ab}>27,

$${S}_{a} = 0.7 \qquad [ Equation 21 ]$$

$${S}_{b} = 0.7$$

$$Δ {E}_{a b}^{′} ( γ ) = \sqrt{{( \frac{Δ {L}^{*} ( γ )}{{g}_{L} \times {S}_{L} ( γ )} )}^{2} + {( \frac{Δ {a}^{*} ( γ )}{{g}_{a} \times {S}_{a}} )}^{2} + {( \frac{Δ {b}^{*} ( γ )}{{g}_{b} \times {S}_{b}} )}^{2}}$$

When chromatic colors are defined by C*_{ab}>10, C*_{ab}<18, and L*_{ab}>27,

$$Δ {E}_{CH}^{′} ( γ ) = \sqrt{{( \frac{Δ {L}^{*} ( γ )}{{g}_{L} \times {S}_{L} ( γ )} )}^{2} + {( \frac{Δ {C}^{*} ( γ )}{{g}_{C} \times {S}_{C} ( γ )} )}^{2} + {( \frac{Δ {H}^{*} ( γ )}{{g}_{H} \times {S}_{H} ( γ )} )}^{2}} \qquad [ Equation 22 ]$$

The formulas ΔE′ab(γ) and ΔE′_{CH}(γ) do not bring the same color difference value in boundary regions, so smoothing is performed.

$$Co ( γ ) = 10 + \frac{8}{1 + {e}^{( 27 - L ( γ ) )}} \qquad [ Equation 23 ]$$

$$σ ( γ ) = \frac{1}{1 + {e}^{( {C}^{*} ( γ ) - Co ( γ ) )}}$$

$$Δ {E}_{eff} ( γ ) = σ ( γ ) \times Δ {E}_{ab}^{′} ( γ ) + ( 1 - σ ( γ ) ) \times Δ {E}_{CH}^{′} ( γ )$$

The equation ΔE_{eff}(γ), which is defined as described above, is called the D6175-2 color difference formula.

Similarly, ΔE_{eff}(γ) is also split into vectors in the a*-b* space. When the target T is defined by (a*, b*)=(a0, b0) and the sample S is defined by (a*, b*)=(a1, b1), an angle θ formed by the vector ΔE_{eff}(γ) with respect to an axis a* is expressed by

θ=tan⁻¹(Δb*/Δa*), where Δa* is a1 minus a0, and Δb* is b1 minus b0

When, in the color difference formula DIN6175-2, a change in lightness represents ΔL*_{eff}(γ), a change in red and green represents Δa*_{eff}(γ), and a change in blue and yellow represents Δb*_{eff}(γ), these are expressed by the following equations.

$$Δ {L}_{eff}^{*} ( γ ) = \frac{Δ {L}^{*} ( γ )}{gL \times SL ( γ )} \qquad [ Equation 24 ]$$

$$Δ {a}_{eff}^{*} ( γ ) = σ ( γ ) \sqrt{{( \frac{Δ {a}^{*} ( γ )}{ga \times Sa} )}^{2} + {( \frac{Δ {b}^{⋆} ( γ )}{gb \times Sb} )}^{2}} cos θ + ( 1 - σ ( γ ) ) \sqrt{{( \frac{Δ {C}^{*} ( γ )}{gC \times SC ( γ )} )}^{2} + {( \frac{Δ {H}^{*} ( γ )}{gH \times SH ( γ )} )}^{2}} cos θ$$

$$Δ {b}_{eff}^{*} ( γ ) = σ ( γ ) \sqrt{{( \frac{Δ {a}^{*} ( γ )}{ga \times Sa} )}^{2} + {( \frac{Δ {b}^{*} ( γ )}{gb \times Sb} )}^{2}} sin θ + ( 1 - σ ( γ ) ) \sqrt{{( \frac{Δ {C}^{*} ( γ )}{gC \times SC ( γ )} )}^{2} + {( \frac{Δ {H}^{*} ( γ )}{gH \times SH ( γ )} )}^{2}} sin θ$$

Furthermore, the sum of these components has a relation of

ΔL*_{eff}(γ)=[(ΔL*_{eff}(γ))²+(Δa*_{eff}(γ))²+(Δb*_{eff}(γ))²]^{1/2}

This means, these correspond to the values of the components when ΔE_{eff}(γ) is split into a direction of ΔL*, a direction of Δa*, and a direction of Δb*. The computational results will be displayed on the display portion 5.

### Embodiment 5

This embodiment is an embodiment using the Audi2000 color difference formula.

The Audi2000 color difference formula presented below is often used as an index for evaluating a color difference of a metallic or pearlescent coating which affects the perceived lightness and color of an object depending on the observation angle.

$${dE}_{γ}^{′} = \sqrt{{( \frac{d {L}_{γ}^{⋆}}{{k}_{dL} \cdot {s}_{{dL}_{γ}}} )}^{2} + {( \frac{{dC}_{γ}^{⋆}}{{k}_{dC} \cdot {s}_{{dC}_{γ}}} )}^{2} + {( \frac{{dH}_{γ}^{⋆}}{{k}_{dH} \cdot {s}_{{dH}_{γ}}} )}^{2}} \qquad [ Equation 25 ]$$

Similarly, ΔE′γ is also split into vectors in the a*-b* space. When the target T is defined by (a*, b*)=(a0, b0) and the sample S is defined by (a*, b*)=(a1, b1), an angle θ formed by the vector ΔE′γ with respect to an axis a* is expressed by

θ=tan⁻¹(Δb*/Δa*), where Δa* is a1 minus a0, and Δb* is b1 minus b0

When, in the Audi2000 color difference formula, a change in lightness represents ΔL′γ, a change in red and green represents Δa′γ, and a change in blue and yellow represents Δb′γ, these are expressed by the following equations.

$$Δ {L}_{γ}^{′} = \frac{d {L}^{*} γ}{kdL \times sdL γ} \qquad [ Equation 26 ]$$

$$Δ {a}_{γ}^{′} = \sqrt{{( \frac{{dC}^{*} γ}{kdC \times sdC γ} )}^{2} + {( \frac{{dH}^{*} γ}{kdH \times sdH γ} )}^{2}} cos θ$$

$$Δ {b}_{γ}^{′} = \sqrt{{( \frac{{dC}^{*} γ}{kdC \times sdC γ} )}^{2} + {( \frac{{dH}^{*} γ}{kdH \times sdH γ} )}^{2}} sin θ$$

Furthermore, the sum of these components has a relation of

ΔE′γ=[(ΔL′γ)²+(Δa′γ)²+(Δb′γ)²]^{1/2}

This means, these correspond to the values of the components when ΔE′γ is split into a direction of ΔL*, a direction of Δa*, and a direction of Δb*. The computational results will be displayed on the display portion 5.

While one embodiment of the present invention has been described in detail, it should be understood that the present invention is in no way limited to the above-described embodiment.

For example, it is a case in which the computing element 4 and the display portion 5 are to embedded in the colorimeter 1. As referred to FIG. 6, the computing element 4 and the display portion 5 may be embedded in an information processing apparatus 20 such as a personal computer, instead of the colorimeter 1. In this case, a colorimetric value obtained by the color measuring portion 2 of the colorimeter 1 is transferred to the information processing apparatus 20 by way of a network or the like. The information processing apparatus 20 receives the colorimetric value by a receiving portion 21 and computes split components with reference to the received colorimetric value and a reference value.

In a case in which a reference value is obtained by color measurement, the color measuring portion 2 of the colorimeter 1 performs color measurement, and the colorimeter 1 transfers the obtained reference value and the colorimetric value of the sample 100 to the information processing apparatus 20. The information processing apparatus 20 receives the reference value and the colorimetric value by the receiving portion 21. Similarly, in a case in which a reference value is retained by the colorimeter 1, the colorimeter 1 transfers the reference value to the information processing apparatus 20. In a case in which a reference value is retained in the information processing apparatus 20, the information processing apparatus 20 internally obtains it. In a case in which a reference value is stored in a location neither the colorimeter 1 nor the information processing apparatus 20, the information processing apparatus 20 obtains the reference value from the location.

### INDUSTRIAL APPLICABILITY

The present invention can serve as: a colorimeter that is capable of computing and displaying a color difference between a reference value and a colorimetric value that is obtained by performing color measurement on a measuring sample; an information processing apparatus; and the like.

### REFERENCE SIGNS LIST

1 Colorimeter
2 Color Measuring Portion
3 Reference Value Obtaining Portion
4 Computing Element
5 Display Portion
8 Case
20 Information Processing Apparatus
21 Receiving Portion
81 Opening
82 Handle Portion
100 Measuring Sample

1-30. (canceled)

31. A color difference computing apparatus comprising:
a processor configured to compute ΔL*₉₄, Δa*₉₄, and Δb*₉₄ with reference to a colorimetric value obtained by color measurement on a measuring sample and a reference value, the ΔL*₉₄, Δa*₉₄, and Δb*₉₄ having a relation of a color difference formula,
ΔE*₉₄=[(ΔL*₉₄)²+(Δa*₉₄)²+(Δb*₉₄)²]^{1/2}
where the ΔL*₉₄ corresponds to a difference in lightness, the Δa*₉₄ corresponds to a difference in red and green, and the Δb*₉₄ corresponds to a difference in blue and yellow; and
a display configured to display computational results obtained by the processor.

32. The color difference computing apparatus as recited in claim 31, wherein the processor calculates the ΔL*₉₄, Δa*₉₄, and Δb*₉₄ by equations presented below:
$$Δ {L}^{{⋆}_{94}} = \frac{Δ {L}^{⋆}}{KL \times SL}$$
$$Δ {a}^{{⋆}_{94}} = \sqrt{{( \frac{Δ {C}^{⋆}}{KC \times SC} )}^{2} + {( \frac{Δ {H}^{⋆}}{KH \times SH} )}^{2}} cos θ$$
$$Δ {b}^{{⋆}_{94}} = \sqrt{{( \frac{Δ {C}^{⋆}}{KC \times SC} )}^{2} + {( \frac{Δ {H}^{⋆}}{KH \times SH} )}^{2}} sin θ .$$

33. A color difference computing apparatus comprising:
a processor configured to compute ΔL*_{cmc}, Δa*_{cmc}, and Δb*_{cmc} with reference to a colorimetric value obtained by color measurement on a measuring sample and a reference value, the ΔL*_{cmc}, Δa*_{cmc}, and Δb*_{cmc} having a relation of a color difference formula,
ΔE_{cmc}=[(ΔL*_{cmc})²+(Δa*_{cmc})²+(Δb*_{cmc})²]^{1/2}
where the ΔL*_{cmc} corresponds to a difference in lightness, the Δa*_{cmc} corresponds to a difference in red and green, and the Δb*_{cmc} corresponds to a difference in blue and yellow; and
a display configured to display computational results obtained by the processor.

34. The color difference computing apparatus as recited in claim 33, wherein the processor calculates the ΔL*_{cmc}, Δa*_{cmc}, and Δb*_{c}mc by equations presented below:
$$Δ {L}^{{⋆}_{cmc}} = \frac{Δ {L}^{⋆}}{l \times SL}$$
$$Δ {a}^{{⋆}_{cmc}} = \sqrt{{( \frac{Δ {C}^{⋆}}{c \times Sc} )}^{2} + {( \frac{Δ {H}^{⋆}}{SH} )}^{2}} cos θ$$
$$Δ {b}^{{⋆}_{cmc}} = \sqrt{{( \frac{Δ {C}^{⋆}}{c \times Sc} )}^{2} + {( \frac{Δ {H}^{⋆}}{SH} )}^{2}} sin θ .$$

35. A color difference computing apparatus comprising:
a processor configured to compute ΔL*₀₀, Δa*₀₀, and Δb*₀₀ with reference to a colorimetric value obtained by color measurement on a measuring sample and a reference value, the ΔL*₀₀, Δa*₀₀, and Δb*₀₀ having a relation of a CIEDE2000 color difference formula,
ΔE*₀₀=[(ΔL*₀₀)²+(Δa*₀₀)²+(Δb*₀₀)²]^{1/2}
where the ΔL*₀₀ corresponds to a difference in lightness, the Δa*₀₀ corresponds to a difference in red and green, and the Δb*₀₀ corresponds to a difference in blue and yellow; and
a display configured to display computational results obtained by the processor.

36. The color difference computing apparatus as recited in claim 35, wherein the processor calculates the ΔL*₀₀, Δa*₀₀, and Δb*₀₀ by equations presented below:
$$Δ {L}^{{⋆}_{00}} = \frac{Δ {L}^{⋆}}{KL \times SL}$$
$$Δ {a}^{{⋆}_{00}} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} cos θ$$
$$Δ {b}^{{⋆}_{00}} = \sqrt{{( \frac{Δ {C}^{′}}{KC \times SC} )}^{2} + {( \frac{Δ {H}^{′}}{KH \times SH} )}^{2} + Rt \times \frac{Δ {C}^{′}}{KC \times SC} \times \frac{Δ {H}^{′}}{KH \times SH}} sin θ .$$

37. A color difference computing apparatus comprising:
a processor configured to compute ΔL*_{eff}(γ), Δa*_{eff}(γ), and Δb*_{eff}(γ) with reference to a colorimetric value obtained by color measurement on a measuring sample and a reference value, the ΔL*_{eff}(γ), Δa*_{eff}(γ), and Δb*_{eff}(γ) having a relation of a DIN6175-2 color difference formula,
ΔL*_{eff}(γ)=[(ΔL*_{eff}(γ))²+(Δa*_{eff}(γ))²+(Δb*_{eff}(γ))²]^{1/2}
where the ΔL*_{eff}(γ) corresponds to a difference in lightness, the Δa*_{eff}(γ) corresponds to a difference in red and green, and the Δb*_{eff}(γ) corresponds to a difference in blue and yellow; and
a display configured to display computational results obtained by the processor.

38. The color difference computing apparatus as recited in claim 37, wherein the processor calculates the ΔL*_{eff}(γ), Δa*_{eff}(γ), and Δb*_{eff}(γ) by equations presented below:
$$Δ {L}^{{⋆}_{eff}} ( γ ) = \frac{Δ {L}^{⋆} ( γ )}{gL \times SL ( γ )}$$
$$Δ {a}^{{⋆}_{eff}} ( γ ) = σ ( γ ) \sqrt{{( \frac{Δ {a}^{⋆} ( γ )}{ga \times Sa} )}^{2} + {( \frac{Δ {b}^{⋆} ( γ )}{gb \times Sb} )}^{2}} cos θ + ( 1 - σ ( γ ) ) \sqrt{{( \frac{Δ {C}^{⋆} ( γ )}{gC \times SC ( γ )} )}^{2} + {( \frac{Δ {H}^{⋆} ( γ )}{gH \times SH ( γ )} )}^{2}} cos θ$$
$$Δ {b}^{{⋆}_{eff}} ( γ ) = σ ( γ ) \sqrt{{( \frac{Δ {a}^{⋆} ( γ )}{ga \times Sa} )}^{2} + {( \frac{Δ {b}^{⋆} ( γ )}{gb \times Sb} )}^{2}} sin θ + ( 1 - σ ( γ ) ) \sqrt{{( \frac{Δ {C}^{⋆} ( γ )}{gC \times SC ( γ )} )}^{2} + {( \frac{Δ {H}^{⋆} ( γ )}{gH \times SH ( γ )} )}^{2}} sin θ .$$

39. A color difference computing apparatus comprising:
a processor configured to compute ΔL′γ, Δa′γ, and Δb′γ with reference to a colorimetric value obtained by color measurement on a measuring sample and a reference value, the ΔL′γ, Δa′γ, and Δb′γ having a relation of an Audi2000 color difference formula,
ΔE′γ=[(ΔL′γ)²+(Δa′γ)²+(Δb′γ)²]^{1/2}
where the ΔL*γ corresponds to a difference in lightness, the Δa*γ corresponds to a difference in red and green, and the Δb*γ corresponds to a difference in blue and yellow; and
a display configured to display computational results obtained by the processor.

40. The color difference computing apparatus as recited in claim 39, wherein the processor calculates the ΔL′γ, Δa′γ, and Δb′γ by equations presented below:
$$Δ {L}_{γ}^{′} = \frac{d {L}^{*} γ}{kdL \times sdLγ}$$
$$Δ {a}_{γ}^{′} = \sqrt{{( \frac{{dC}^{*} γ}{kdC \times sdC γ} )}^{2} + {( \frac{{dH}^{*} γ}{kdH \times sdH γ} )}^{2}} cos θ$$
$$Δ {b}_{γ}^{′} = \sqrt{{( \frac{{dC}^{*} γ}{kdC \times sdC γ} )}^{2} + {( \frac{{dH}^{*} γ}{kdH \times sdH γ} )}^{2}} sin θ .$$

41. A colorimeter comprising:
the color difference computing apparatus as recited in claim 31, wherein the processor configured to obtain the reference value; and
color measuring portion to obtain the colorimetric value by performing color measurement on the measuring sample.

42. A colorimeter comprising:
the color difference computing apparatus as recited in claim 33, wherein the processor configured to obtain the reference value; and
color measuring portion to obtain the colorimetric value by performing color measurement on the measuring sample.

43. A colorimeter comprising:
the color difference computing apparatus as recited in claim 35, wherein the processor configured to obtain the reference value; and
color measuring portion to obtain the colorimetric value by performing color measurement on the measuring sample.

44. A colorimeter comprising:
the color difference computing apparatus as recited in claim 37, wherein the processor configured to obtain the reference value; and
color measuring portion to obtain the colorimetric value by performing color measurement on the measuring sample.

45. A colorimeter comprising:
the color difference computing apparatus as recited in claim 39, wherein the processor configured to obtain the reference value; and
color measuring portion to obtain the colorimetric value by performing color measurement on the measuring sample.

46. An information processing apparatus comprising:
the color difference computing apparatus as recited in claim 31, wherein the processor configured to receive the colorimetric value from a colorimeter, the colorimetric value being obtained by color measurement on the measuring sample, and obtain the reference value.

47. An information processing apparatus comprising:
the color difference computing apparatus as recited in claim 33, wherein the processor configured to receive the colorimetric value from a colorimeter, the colorimetric value being obtained by color measurement on the measuring sample, and obtain the reference value.

48. An information processing apparatus comprising:
the color difference computing apparatus as recited in claim 35, wherein the processor configured to receive the colorimetric value from a colorimeter, the colorimetric value being obtained by color measurement on the measuring sample, and obtain the reference value.

49. An information processing apparatus comprising:
the color difference computing apparatus as recited in claim 37, wherein the processor configured to receive the colorimetric value from a colorimeter, the colorimetric value being obtained by color measurement on the measuring sample, and obtain the reference value.

50. An information processing apparatus comprising:
the color difference computing apparatus as recited in claim 39, wherein the processor configured to receive the colorimetric value from a colorimeter, the colorimetric value being obtained by color measurement on the measuring sample, and obtain the reference value.
